(19) United States
(12) Patent Application Publication
(10) Pub. No.: US 2025/0149945 A1
(43) Pub. Date: May 8, 2025

(54) ELECTRIC AXIAL FLUX MACHINE

(71) Applicant: Schaeffler Technologies AG & Co. KG, Herzogenaurach (DE)

(72) Inventors: Dirk Reimnitz, Bühl (DE); Stefan Rieß, Kaufering (DE)

(73) Assignee: Schaeffler Technologies AG & Co. KG, Herzogenaurach (DE)

(21) Appl. No.: 18/837,887

(22) PCT Filed: Feb. 2, 2023
(86) PCT No.: PCT/DE2023/100082

§ 371 Date: Aug. 13, 2024

(30) Foreign Application Priority Data
Feb. 14, 2022 (DE) 10 2022 103 388.0
Jun. 9, 2022 (DE) 10 2022 114 477.1

(51) Int. Cl. H02K 3/28; H02K 1/18; H02K 11/33

(52) U.S. Cl. CPC H02K 3/28; H02K 1/182; H02K 11/33; H02K 2203/09

(57) ABSTRACT

An electrical axial flux machine, in particular for a drive train of a hybrid or fully electrically operated motor vehicle is provided. The axial flux machine includes a stator having a plurality of stator coils distributed over the circumference of the stator; power electronics for supplying current to the stator coils; and a high-voltage terminal for establishing an electrical connection between the stator coils and the power electronics. Busbars are located above the stator coils, in the radial direction. The busbars enclosing, in an annular manner, the stator and/or a rotor that can be rotated relative to the stator, and electrically conductively connecting the stator coils to the high-voltage terminal.

### CROSS-REFERENCE TO RELATED APPLICATIONS

This application is the U.S. National Phase of PCT Appln. No. PCT/DE2023/100082 filed Feb. 2, 2023, which claims priority to DE 10 2022 103 388.0 filed Feb. 14, 2022 and DE 10 2022 114 477.1 filed Jun. 9, 2022, the entire disclosures of which are incorporated by reference herein.

### TECHNICAL FIELD

The present disclosure relates to an electric axial flux machine, in particular for a drive train of a hybrid or fully electrically operated motor vehicle, comprising a stator having a plurality of stator coils distributed over the circumference of the stator and power electronics for supplying current to the stator coils and a high-voltage terminal for establishing an electrical connection between the stator coils and the power electronics.

### BACKGROUND

Electric motors are increasingly being used to drive motor vehicles in order to create alternatives to internal combustion engines that require fossil fuels. Significant efforts have already been made to improve the suitability of electric drives for everyday use and also to be able to offer users the driving comfort to which they are accustomed.

A detailed description of an electric drive can be found in an article in the German automotive magazine ATZ, volume 113, May 2011, pages 10-14 by Erik Schneider, Frank Fickl, Bernd Cebulski and Jens Liebold with the title: “Hochintegrativ und flexibel—Elektrische Antriebseinheit für E-Fahrzeuge” [Highly Integrative and Flexible—Electric Drive Unit for Electric Vehicles], which is probably the closest prior art. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between climbing ability, acceleration and energy consumption due to the shiftable 2-speed planetary gear set. Such drive units are also referred to as e-axles or electrically operable drive trains.

Increasingly, axial flux machines are also used in such e-axles. An axial flux machine is a dynamo-electric machine in which the magnetic flux between the rotor and stator runs parallel to the rotational axis of the rotor. Often, both the stator and the rotor are designed to be largely disc-shaped. Axial flux machines are particularly advantageous when the axially available installation space is limited in a given application. This is often the case, for example, with the electric drive systems for electric vehicles described at the outset. In addition to the shortened axial installation length, a further advantage of the axial flux machine is its comparatively high torque density. The reason for this is, compared to radial flux machines, the larger air gap area which is available for a given installation space. Furthermore, a lower iron volume is required compared to conventional machines, which has a positive effect on the efficiency of the machine.

Due to its disc-shaped main components, an axial flux machine is particularly suitable for applications where a very short installation length of the electric motor is important and where a relatively large motor diameter is still acceptable. When developing corresponding axial flux machines, it is therefore usually sensible to aim for the shortest possible design, although the outer diameter of the axial flux machine should not be larger than absolutely necessary. In the case of axial flux machines for motor vehicles, there are also always requirements for low weight, high power density and low costs. This also applies to the power supply of an axial flux machine.

### SUMMARY

It is therefore the object of the disclosure to provide an axial flux machine that is particularly compact both axially and radially.

This object is achieved by an electric axial flux machine, in particular for a drive train of a hybrid or fully electrically operated motor vehicle, comprising a stator having a plurality of stator coils distributed over the circumference of the stator and power electronics for supplying current to the stator coils and a high-voltage terminal for establishing an electrical connection between the stator coils and the power electronics, wherein busbars are located above the stator coils in the radial direction, said busbars enclosing, in an annular manner, the stator and/or a rotor that can be rotated relative to the stator and electrically conductively connecting the stator coils to the high-voltage terminal.

This has the advantage that an axially particularly short design of the axial flux machine can be realized by arranging the busbar, which supplies current to the stator coils of the electromagnets, radially outside the rotor. All electrical connections between the stator coils can be made radially outside the stator coils or radially outside the rotor. Electrical connections between the coils are not required either in the radial area of the stator coils or in the radial area within the stator coils.

The annular busbars can be closed all around or open at one point on the circumference. The busbars can also be designed to enclose only part of the circumference.

The individual elements of the claimed subject matter of the disclosure will be explained herein in along with preferred embodiments of the subject matter of the disclosure will be described.

The magnetic flux in an electric axial flux machine (AFM), such as an electric drive machine of a motor vehicle designed as an axial flux machine, is directed axially to a direction of rotation of the rotor of the axial flux machine in the air gap between the stator and the rotor.

Depending on the application, it may be advantageous to design an axial flux machine in an I-arrangement or an H-arrangement. In an I-arrangement, the rotor is arranged axially next to a stator or between two stators. In an H-arrangement, two rotors are arranged on opposite axial sides of a stator. The electric axial flux machine according to the disclosure is preferably configured in an I-arrangement.

In principle, it is also possible for a plurality of rotor-stator configurations to be arranged axially adjacent as an I-type and/or H-type. In this context, it would also be possible to arrange several I-type rotor-stator configurations next to each other in the axial direction. In particular, it is also preferable that the rotor-stator configurations of the H-type and/or the I-type are each designed to be substantially identical, so that they can be assembled in a modular manner to form an overall configuration. Such rotor-stator configurations can in particular be arranged to be coaxial to one another and can be connected to a common rotor shaft or to a plurality of rotor shafts.

The stator of the electric axial flux machine according to the disclosure preferably has a stator body with a plurality of stator windings arranged in the circumferential direction. The stator body can be designed to be in one piece or segmented, as seen in the circumferential direction. The stator body can be formed from a laminated stator core with a plurality of laminated electrical sheets. Alternatively, the stator body can also be formed from a compressed soft magnetic material, such as what is termed an SMC (soft magnetic composite) material.

The rotor of an electric axial flux machine can be designed at least in parts as a laminated rotor. A laminated rotor is designed to be layered in the radial direction. Alternatively, the rotor of an axial flux machine can also have a rotor carrier which is correspondingly equipped with magnetic sheets and/or SMC material and with magnetic elements designed as permanent magnets.

A rotor shaft is a rotatably mounted shaft of an electric machine to which the rotor or rotor body is coupled in a non-rotatable manner.

The electric axial flux machine can furthermore have a controller. A controller, such as may be used in the present disclosure, is used in particular for the electronic control and/or regulation of one or a plurality of technical systems of the electric axial flux machine.

A controller has, in particular, a wired or wireless signal input for receiving in particular electrical signals, such as sensor signals, for example. Furthermore, a controller also preferably has a wired or wireless signal output for transmitting electrical signals in particular.

Control operations and/or regulation operations can be carried out within the controller. It is very particularly preferred for the controller to comprise hardware that is designed to run software. The controller preferably comprises at least one electronic processor for executing program sequences defined in software.

The controller can furthermore have one or a plurality of electronic memories in which the data contained in the signals transmitted to the controller can be stored and read out again. Furthermore, the controller can have one or more electronic memories in which data can be stored in a modifiable and/or non-modifiable manner.

A controller can comprise a plurality of control devices which are arranged in particular spatially separate from one another in the motor vehicle. Control devices are also referred to as electronic control units (ECU) or electronic control modules (ECM) and preferably have electronic microcontrollers for carrying out computing operations for processing data, particularly preferably using software. The control devices can preferably be interconnected with one another such that a wired and/or wireless data exchange between control devices is made possible. In particular, it is also possible to interconnect the control devices with one another via bus systems present in the motor vehicle, such as a CAN bus or LIN bus for example.

Very particularly preferably, the controller has at least one processor and at least one memory, which in particular contains a computer program code, the memory and the computer program code being configured with the processor to cause the controller to execute the computer program code.

The control unit can particularly preferably comprise power electronics for supplying current to the stator or rotor. Power electronics are preferably a combination of different components that control or regulate a current to the electric machine, preferably including the peripheral components required for this purpose, such as cooling elements or power supply units. In particular, the power electronics contains one or more power electronics components that are configured to control or regulate a current. These are particularly preferably one or a plurality of power switches, such as power transistors. The power electronics particularly preferably has more than two, particularly preferably three, phases or current paths which are separate from one another and each have at least one separate power electronics component. The power electronics are preferably designed to control or regulate a power with a peak power, preferably continuous power, of at least 1,000 W, preferably at least 10,000 W, particularly preferably at least 100,000 W per phase.

The electric axial flux machine is intended in particular for use within a drive train of a hybrid or fully electrically operated motor vehicle. In particular, the electric machine is dimensioned such that vehicle speeds of more than 50 km/h, preferably more than 80 km/h and in particular more than 100 km/h can be achieved. The electric motor particularly preferably has an output of more than 50 kW, preferably more than 100 KW and in particular more than 250 kW. Furthermore, it is preferred that the electric machine provides operating speeds greater than 5,000 rpm, particularly preferably greater than 10,000 rpm, very particularly preferably greater than 12,500 rpm. Most preferably, the electric machine has operating speeds between 5,000-15,000 rpm, most preferably between 7,500-13,000 rpm.

The electric axial flux machine can preferably also be installed in an electrically operated axle drive train. An electric axle drive train of a motor vehicle comprises an electric axial flux machine and a transmission, wherein the electric axial flux machine and the transmission forms a structural unit. It can also be particularly provided that the electric axial flux machine and the transmission are arranged in a common drive train housing. Alternatively, it would of course also be possible for the electric axial flux machine to have a motor housing and the transmission to have a transmission housing, in which case the structural unit can then be effected by fixing the transmission in relation to the electric axial flux machine. This structural unit is sometimes also referred to as an e-axle.

The electric axial flux machine can also be particularly preferably designed for use in a hybrid module. In a hybrid module, structural and functional elements of a hybridized drive train can be spatially and/or structurally combined and preconfigured such that a hybrid module can be integrated into a drive train of a motor vehicle in a particularly simple manner. In particular, an axial flux machine and a clutch system, in particular with a disconnect-type clutch for engaging the axial flux machine in and/or disengaging the axial flux machine from the drive train, can be present in a hybrid module.

A high-voltage terminal within the meaning of this application is the particularly detachable connection point between the busbars and the electrical conductors (e.g. cables) that connect the electric machine to the power electronics (and consists of the components that form this connection point). These can, for example, include busbars with connection points for the electric connection to the power electronics and preferably also connection points for the busbars of the electric machine. The connection points can be designed, for example, as screw and/or plug contacts. In particular, the high-voltage terminal is designed to connect a multi-phase power connection.

Advantageous embodiments of the disclosure are specified in the claims, disclosure and figures. The features listed individually in the claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that the high-voltage terminal is positioned radially above the busbars, which also contributes to a compact axial design and good mountability of the power connections.

According to a further preferred further development of the disclosure, it may also be provided that the stator coils each have a first coil end and a second coil end, wherein the first coil end has a radially extending section and an axially extending section, and the axially extending section electrically contacts one of the busbars and/or the second coil end has a radially extending section and an axially extending section, and the axially extending section electrically contacts one of the busbars or a star point rail or another coil. This can also support a particularly compact axial design of the axial flux machine. Furthermore, this can also help to ensure that the stator coils are of the same size, with corresponding cost advantages.

Furthermore, according to an equally advantageous embodiment of the disclosure, it can be provided that the axial flux machine is configured in an I-design, in which the rotor has a first disc-shaped stator body and a second disc-shaped stator body axially spaced therefrom and a rotor is arranged axially between the first stator body and the second stator body, wherein the first stator body has a plurality of first stator coils distributed over the circumference of the first stator body and the second stator body has a plurality of second stator coils distributed over the circumference of the second stator body, and first busbars are located above the first stator coils in the radial direction, said busbars enclosing, in an annular manner, the first stator body and electrically conductively connecting the first stator coils and/or the second stator coils to the high-voltage terminal and second busbars are located above the second stator coils in the radial direction, said busbars enclosing, in an annular manner, the second stator body and electrically conductively connecting the first stator coils and/or the second stator coils to the high-voltage terminal.

The advantageous effect of this design is based on the fact that, in the case of an axial flux machine in an I-arrangement, the busbars and the connecting area for both stator bodies can be arranged radially outside the rotor. Almost all current-carrying components of the connecting area can thus be arranged radially outside the stator coils of the electromagnets and are also located axially within the axial area, which corresponds to the width of the rotor plus half the width of the two laterally adjacent stator bodies.

Thus, an axial flux machine in I-arrangement can be provided, the busbars and the connecting areas for both stator bodies of which lie axially within the axial area between the side of the stator iron (yoke) of one stator body facing away from the rotor and the side of the stator iron (yoke) of the other stator body facing away from the rotor. Due to the radial arrangement of busbars and coil wiring or connection, the axial length of the axial flux machine in I-configuration can be made very short.

Furthermore, the two opposing stator coils connected in series can preferably be connected to a common busbar system radially outside the rotor. The busbar system can be aligned centrally to the rotor so that the connecting wires of the stator coils in the opposite stator bodies can be made the same length and thus identical stator coils can be used for both stator bodies. This makes it very easy to implement even very short winding ends of the stator coils as well as a series connection of the opposing stator coils. Furthermore, the wiring and contact positions are easily accessible, which makes assembly noticeably easier.

Alternatively, the opposite stator coils (i.e. on opposite sides of the rotor) could be connected to a common busbar system without the stator coils having to be connected in series.

According to a further particularly preferable embodiment of the disclosure, it can be provided that the stator coils are designed to be substantially identical, which can contribute to a clear cost optimization of the axial flux machine.

In another preferable embodiment of the disclosure, it can also be provided that the first busbars and the second busbars are connected to the common high-voltage terminal.

It may also be advantageous to further develop the disclosure in such a way that the busbars are accommodated at least in sections in an annular or ring-segment-shaped insulating body, which on the one hand simplifies the defined fixing of the busbars to one another and at the same time can provide electrical insulation of the busbars from one another.

According to a further preferable embodiment of the subject matter of the disclosure, it can be provided that the insulating body has an E-shaped contour in cross-section with two radially spaced-apart grooves open on one side, in which the busbars are accommodated, which has proven to be particularly favorable in terms of production and assembly.

Furthermore, according to a further preferred embodiment of the disclosure, it is advantageous that an axial and radial elastic movement decoupling takes place between the stator and the power connections. This can be achieved, for example, by elastically deformable busbars and/or elastically deformable connecting lugs between the busbars and the power connection bolts.

Finally, it may also be preferred that a pair of coils arranged on opposite sides of the rotor are electrically connected in series.

### BRIEF DESCRIPTION OF THE DRAWINGS

The disclosure is explained in more detail below with reference to figures without limiting the general concept of the disclosure.

In the figures:

FIG. 1 shows an axial flux machine in a schematic axial sectional view,

FIG. 2 shows a detailed view of the axial flux machine of FIG. 1 in an axial sectional view,

FIG. 3 shows a detailed view of the axial flux machine of FIG. 1 in an axial sectional view,

FIG. 4 shows an isolated view of the coil connection of an axial flux machine in a perspective view,

FIG. 5 shows a detailed view of the coil connection of the axial flux machine of FIG. 4 in a perspective view,

FIG. 6 shows a hybrid and fully electrically operated motor vehicle in a block diagram.

### DETAILED DESCRIPTION

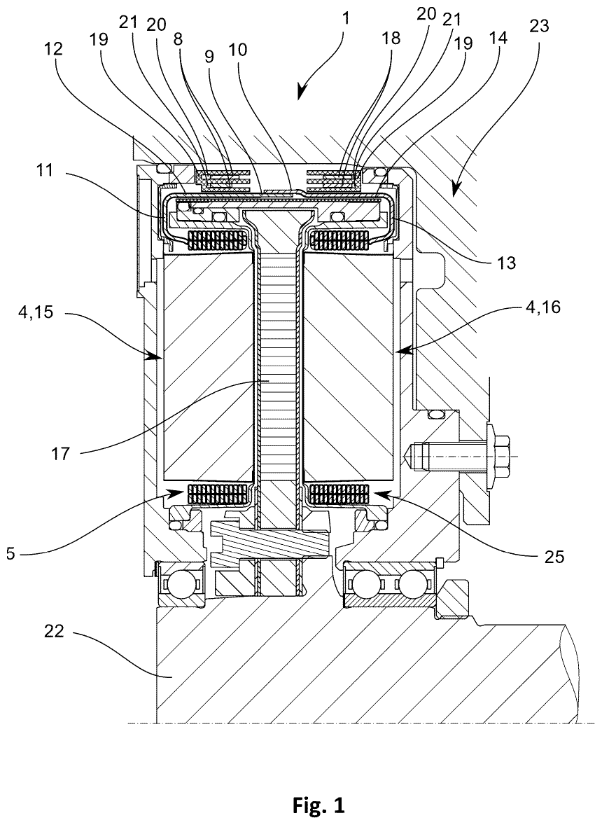

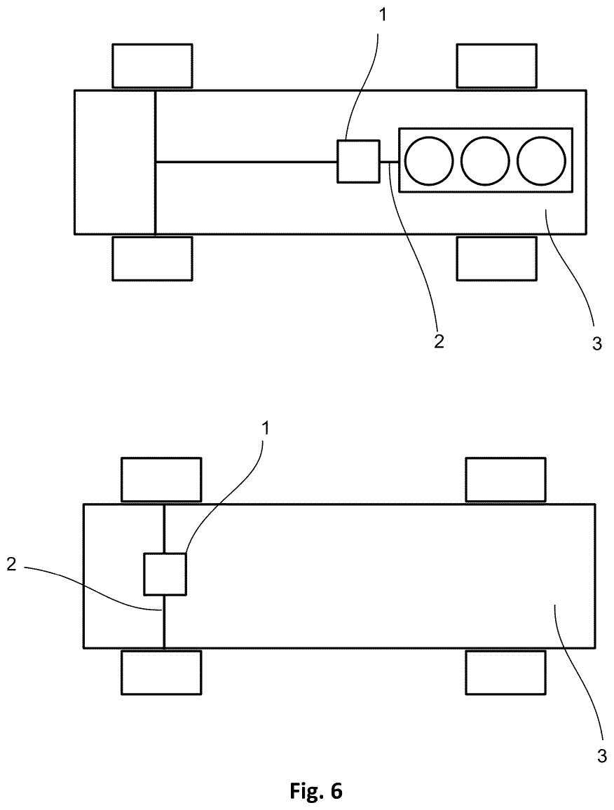

FIG. 1 shows an electric axial flux machine 1, in particular for a drive train 2 of a hybrid or fully electrically operated motor vehicle 3, as shown as an example in FIG. 6.

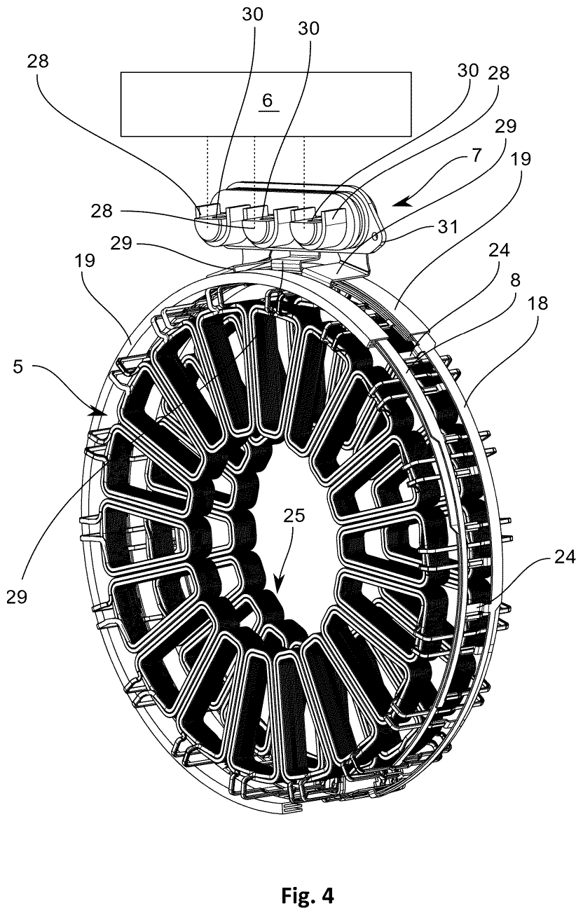

The axial flux machine 1 shown comprises a stator 4 having a plurality of stator coils 5 distributed over the circumference of the stator 4 and power electronics 6 for supplying current to the stator coils 5 and a high-voltage terminal 7 for establishing an electrical connection between the stator coils 5 and the power electronics 6, which can be easily seen from the combined view of FIGS. 1 and 4.

Busbars 8 are located above the stator coils 5 in the radial direction, said busbars enclosing, in an annular manner, the stator 4 and electrically conductively connecting the stator coils 5 to the high-voltage terminal 7. As shown in FIG. 1, the axial flux machine 1 is configured in an I-arrangement, in which the stator 4 has a first disc-shaped stator body 15 and a second disc-shaped stator body 16 axially spaced therefrom and a rotor 17 is arranged axially between the first stator body 15 and the second stator body 16.

The first stator body 15 has a plurality of first stator coils 5 distributed over the circumference of the first stator body 15 and the second stator body 16 has a plurality of second stator coils 25 distributed over the circumference of the second stator body 16. First busbars 8 are located above the first stator coils 5 in the radial direction, said busbars enclosing, in an annular manner, the first stator body 15 and electrically conductively connecting the first stator coils 5 and/or the second stator coils 25 to the high-voltage terminal 7. Second busbars 18 are located above the second stator coils 25 in the radial direction, which analogously enclose the second stator body 15 in an annular shape and connect the first stator coils 5 and/or the second stator coils 25 in an electrically conductive manner to the high-voltage terminal 7.

The stator 4 consists of two stator bodies 15,16 connected to one another radially on the outside, each of which is connected to the rotor shaft 22 radially on the inside via a bearing point in a rotationally decoupled manner. The rotor 17 is fastened to the rotor shaft 22 and consists of a disc-shaped section extending radially outwards between the two stator bodies 15,16. The air gaps through which the axial magnetic flux of the axial flux machine 1 runs are located between the two stator bodies 15,16 and the rotor 17. The magnetic spring of the axial flux machine 1 can cause a torque that acts on the rotor 17 and is introduced into the rotor shaft 22 by said rotor. The rotor shaft 22 protrudes in the axial direction from the axial flux machine 1 and thus forms the transmission element, through which the torque of the electric axial flux machine 1 can be transmitted to an adjacent unit. This neighboring unit can be, for example, a transmission, a differential, a shaft or a wheel of the motor vehicle 3.

The stator half facing the transmission is connected radially on the inside to the housing 23, which surrounds the electric axial flux machine 1. For this purpose, the housing 23 has a side wall or intermediate wall which is screwed to the second stator body 16. It makes sense in this regard to arrange a plurality of screws distributed around the circumference. The rotor 17 is rotationally decoupled from the stator 4 by bearings between the stator bodies 15,16 and the rotor shaft 22.

In the axial flux machine 1 shown in half section in FIG. 1, the rotor 17 is equipped with permanent magnets and the stator 4 with electromagnets. In both stator bodies 15,16, a plurality of electromagnets (poles) are arranged distributed around the circumference, each consisting of a coil 5,25 that runs around a coil core (a tooth of the stator iron). An electromagnet of one stator body 15,16 and an electromagnet of the other stator body 15,16 are always arranged on the opposite sides of the rotor 17. The coils 5,25 of these two electromagnets form a coil pair, the coils of which are arranged exactly one behind the other in the axial direction (on the opposite sides of the rotor 17). The cutting plane of FIG. 1 runs through such a pair of coils. In the exemplary embodiment shown, these two coils 5,25 are electrically connected in series so that the output of one coil 5,25 is connected to the input of the other coil 5,25.

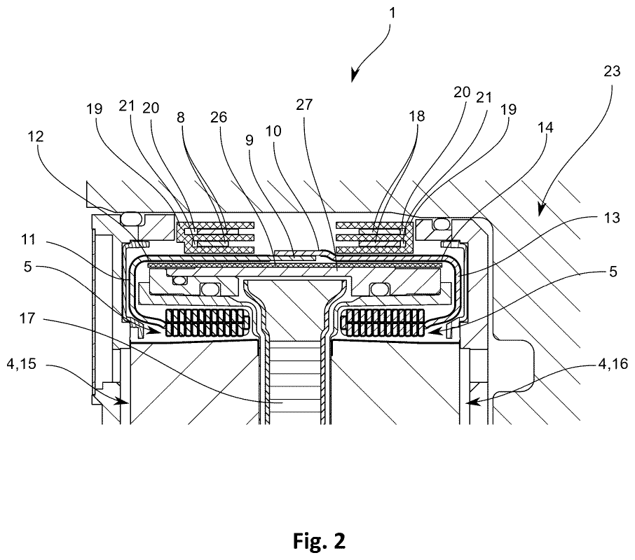

FIG. 2 shows in the sectional plane how the wire of one coil 5 leads axially away from the wound coil body, then runs radially outwards through an opening between the components forming the support structure of the stator 4 and then runs axially back in the direction of the rotor 17. The opposite coil 25 of the coil pair 5,25 has a comparable coil end 10 which meets the other coil end 9. Both coil ends 9,10 meet radially outside the rotor 17 and can be electrically connected to each other there. In the exemplary embodiment shown, the coil ends 9,10 overlap. The overlapping parts of the coil ends 9,10 are freed from the insulating layer surrounding the coil wire and are connected to each other, for example welded, soldered or pressed.

The power supply of all coils 5,25 arranged on the circumference of the axial flux machine 1 is ensured by a system of busbars 8,18 arranged radially outside the rotor 17. In the exemplary embodiment, three current busbars (current phase-U, current phase-V and current phase-W) and a star point rail are located in the circumferential space formed by the stator 4 and the motor housing 23, radially outside the rotor 17, in which the connection point just described between the coils 5,25 belonging to a pair of coils is also located. These four electrical conductors (rails) are designed as curved sheet metal components (e.g. copper sheet) that run completely or almost completely around the axial flux machine 1. Two of these busbars 8,18 are arranged in an insulating body 19 that is open on one side. This insulating body 19 runs in an annular shape around the electric axial flux machine 1 and has a rectangular cross-section with two deep axially running grooves 20,21, so that the cross-section of the insulating body 19 is reminiscent of an “E”.

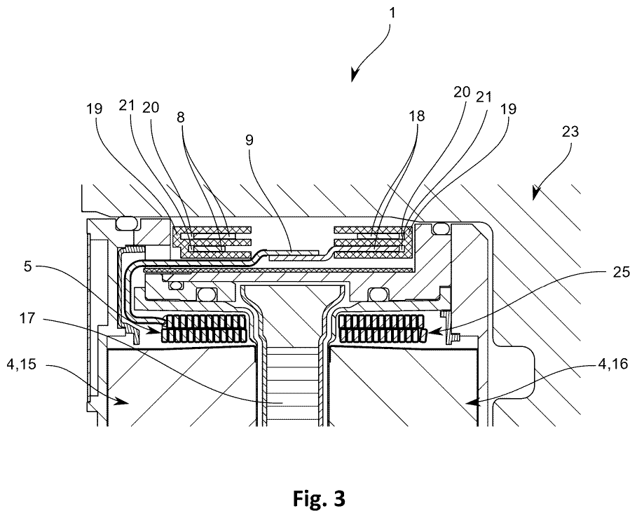

In this exemplary embodiment, two insulating bodies 19 are arranged on the opposite axial sides in the annular space between the stator 4 and the motor housing 23. The grooves 20,21 of the insulating bodies 19 point towards the center and each accommodate one of the current-carrying busbars 8,18 or a star point rail. Starting from the respective circumferential base bodies of the busbars 8,18 or a star point rail, which are arranged completely in the grooves 20,21 of the insulating bodies 19, a plurality of connecting lugs 24 of the busbars 8,18 or star point rail, distributed around the circumference, protrude axially from the grooves 20,21 of the insulating bodies 19. These connecting lugs 24 form the electrical connection points of the busbars 8,18 and the star point rail with which the busbar or star point rails are connected to the coils 5,25, as can also be clearly seen in FIG. 3. The three busbars for the current phases (current phase U, current phase V and current phase W) also each have a connecting lug 24 which is connected to the phase connection of the axial flux machine 1 (power connection bolt).

Alternatively, each current-carrying rail (i.e. busbars and star point rail) can be arranged in a separate insulating body 19, or more than two current-carrying rails can be accommodated in one insulating body 19. The insulating body 19 can have its own circumferential groove 20,21 for each current-carrying rail (for example, several radially staggered grooves 20, 21 one above the other and/or grooves 20, 21 extend from the two axially opposite sides into the cross-section of the insulating body 19). If the current-carrying conductors do not run completely around the electric axial flux machine 1, several rails can also be arranged on different areas of the circumference in a circumferential groove 20, 21 of an insulating body 19.

This is particularly useful, for example, if not only one busbar per phase connection of the axial flux machine 1 is used to electrically supply all the coils 5,25 to be connected to this phase connection, but a plurality of busbars are connected to the phase connection and each of these busbars electrically connects only some of the coils 5,25, which must be connected to this phase connection, to the phase connection. For example, it is possible to arrange a short busbar (e.g. one covering less than 180° of the axial flux machine 1) in one circumferential direction and a second comparable busbar in the other circumferential direction around the axial flux machine 1 from a phase connection, of which each busbar only electrically connects some (e.g. half) of the coils 5,25 to be connected to the phase connection.

Instead of a circumferential star point rail (one that is closed or open at one point on the circumference) to which all coil pairs (or all coils 5,25 of one of the stator bodies 15,16) are connected, several star point rails distributed around the circumference can also be used, to each of which a coil group or an integer number of coil groups, each consisting of a coil pair connected to the current phase U, a coil pair connected to the current phase V and a coil pair connected to the current phase W, are connected. These star point rails, which are not connected to all coil pairs, can also be easily arranged one behind the other in a circumferential groove 20, 21 of an insulating body 19 on the circumference.

Since the insulating bodies 19 insulate the busbars 8,18 towards the edge of the annular space, the busbars 8,18 can be arranged geometrically very close to the stator components made of electrically conductive material and forming the axial side walls of the annular space, without falling below the necessary clearance and creepage distances. Towards the inside, where the two oppositely arranged insulating bodies 19 are open, there is enough space between the conductors to maintain the necessary air and creepage distances. Radially inwardly in the annular space there is another insulating insert 26 (e.g. a plastic film or an insulating paper). This insulating insert 26 can be seen in FIG. 2 between the connection point of the two coils 5,25 of the coil pair and the stator casing 27.

The stator casing 27 is a tubular component that mechanically connects the two stator bodies 15,16 and separates the rotor space from the annular space in which the power supply is housed. The insulating insert 26 creates the necessary clearance and creepage distances from the current-carrying rails and the connection points of the coils 5,25 to the adjacent stator components in a radially inward direction. In the exemplary embodiment shown, there is sufficient clearance radially outward towards the motor housing 23 to maintain the necessary air and creepage distances. Alternatively, a further insulating insert can be used to electrically insulate the annular space towards the motor housing 23 in the radial direction.

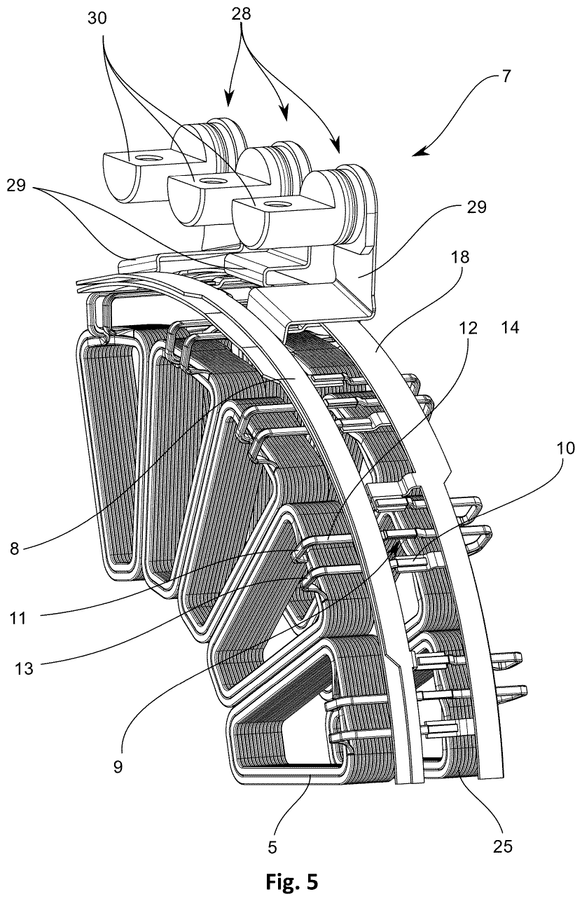

FIG. 3 shows a further detail of the axial flux machine 1 already shown in FIGS. 1-2. The cutting line in FIG. 3 is slightly offset on the circumference compared to that in FIG. 1 and FIG. 2, so that the cutting plane passes through a connection point of the star point rail with a coil 5,25. The connection points between each of the three current rails (current phase U, current phase V and current phase W) and a coil 5,25 are technically detached in an analogous manner. The connection points of the power supply system can also be seen in the following perspective images in FIGS. 4-5. At the connection points between the coils 5,25 and the busbars 8,18, which are designed to overlap in this embodiment, the wire ends of the coils 5,25 are freed from the insulating layer that surrounds the coil wire and are electrically connected (for example welded, soldered, or pressed) to the likewise bare extensions of the current-carrying rails. The electrical connection points of the axial flux machine 1 can be designed butt-joint instead of overlapping and then welded or soldered, for example.

FIGS. 1-3 show that the interconnection and power supply of the coils 5,25 takes place via the power supply system arranged radially above the rotor 17, which essentially consists of the busbars 8,18, the phase connections and the electrical connecting elements or connections between these components and between these components and the coils 5,25. No electrical connection elements are required axially behind the stator iron. In other words, all electrical conductors can be arranged in the central axial region of the axial flux machine 1 by the construction principle described here. This area extends from the side of the stator iron [yoke] of one stator body 15 facing away from the rotor 17 to the side of the stator iron [yoke] of the other stator body 16 facing away from the rotor 17. Since no installation space for electrical conductors has to be provided axially behind the stator iron or even behind the stator side walls, the axial flux machine 1 can be constructed to be axially very short. By integrating the busbars 8,18 into an annular space which is formed by the stator casing 27 and is closed radially on the outside by the motor housing 23, the busbars 8,18 are integrated into the mechanical structure of the stator 4 in a very space-saving manner. Alternatively, the annular space in which the current-carrying rails are housed can also be covered radially on the outside by an additional motor element, so that the current rails are completely enclosed by motor parts and no additional motor housing is required to cover the current-carrying rails.

The stator casing 27 is an annular or tubular component (or an annular or tubular assembly) which completely encloses the rotor 17 and has a flange at each of its two axial end regions, each of which extends radially outward past the annular space and to which a stator side wall is fastened. In the flanges of the stator casing 27, several openings distributed around the circumference are provided through which the connecting wires of the coils 5,25 protrude. It is particularly useful to pull both coil ends 9,10 of a coil 5,25 through the same opening in the flange of the stator casing 27, since this reduces the eddy current losses of the axial flux machine 1. The mechanical connection between the stator casing 27 and the respective stator side wall requires a larger radial installation space than the tubular axial center part of the stator casing 27.

Because the power supply system uses the radial installation space above the tubular axial center part of the stator casing 27, the axial flux machine 1 is not larger radially in large parts of the circumference, even with the power supply system arranged radially on the outside, than it would have to be anyway in order to be able to accommodate the mechanical structure of the stator 4 (e.g. the fastening elements). At the point where the phase connections are arranged radially above the rotor 17, the motor housing 23 must be pulled further radially outwards in order to create space for the phase connections and, if necessary, to mechanically fix the phase connections. However, in the motor design presented here, this additional radial installation space is only required at one point on the motor circumference.

The annular space in which the power supply system and its connection points are accommodated is only closed radially on the outside by mounting the axial flux machine 1 in the motor housing 23. This makes all connection points of the power supply system very easily accessible during the assembly process of the axial flux machine 1. This simplifies assembly and enables welding or soldering processes suitable for large-scale production. The annular space in which the power supply system is housed is sealed by seals (e.g. O-rings) between the stator 4 and the motor housing 23. This prevents the penetration of dirt or moisture and also offers the possibility of flooding the annular space with an intentionally introduced fluid, for example to cool the electrical conductors.

Instead of arranging the phase connections 28 of the high-voltage terminal 7, as shown in the figures, at a point on the circumference of the motor radially outside the otherwise cylindrical motor installation space, the phase connections 28 can alternatively also be arranged at a point on the circumference axially (or axially and radially) outside the otherwise cylindrical motor installation space. Axially offset phase connections 28 can then be arranged, for example, on the same radius as the busbars 8,18 on the front side of the axial flux machine 1. In other words, deviating from FIG. 4 or FIG. 5, the phase connections 28 can alternatively be led out of the axial flux machine 1 axially and/or radially outside the stator geometry. This embodiment can be advantageous according to the installation space integration of the axial flux machine 1. Instead of being positioned in close proximity to one another, the three phase connections 28 can also be distributed around the axial flux machine 1.

FIG. 4 shows the coils 5,25 of an axial flux machine 1 together with a few neighboring components in a correspondingly isolated perspective view. In order to be able to at least partially see the busbars 8,18, the two insulating bodies 19, which actually enclose each current-carrying rail along its entire circumferential length, have been removed over part of the circumference in the front part of the figures. In the embodiment shown here, it can be seen that the width of the busbars 8,18 is gradually reduced the further the areas of the busbars 8,18 are away from the phase connection 28 of the electric axial flux machine 1. Since the electrical current introduced into the busbar 8,18 from the phase connection 28 is distributed among the coils 5,25 connected to the busbar 8,18, the current intensity to be transmitted by the base body of the busbar 8,18 becomes increasingly lower the more coils 5,25 have already been supplied with current. FIG. 4 shows that if the current introduced into the busbar 8,18 from the phase connection 28 to the last coil 5,25 connected at the end of the busbar 8, 18 is notionally followed, the width of the busbar 8,18 becomes narrower after each connecting lug 24 of the busbar 8,18, via which another coil 5,25 is connected. Since less current has to be transmitted through the busbar 8,18 after each connecting lug 24, only a smaller conductor cross-section is required. Reducing the cross-section of the busbar 8,18 saves material and reduces weight and costs.

In FIGS. 4-5, the phase connections 28 of the axial flux machine 1 at the high-voltage terminal 7 can be seen. The high-voltage terminal 7 is positioned radially above the busbars 8,18. Each of the three busbars 8,18 is connected to a power connection bolt 30 by a connecting lug 29. The three power connection bolts 30 are mechanically connected to the remaining motor components via a common base 31. The base 31 mechanically fixes the power connection bolts 30 and electrically insulates the power connection bolts 30. The base 31 also ensures the required clearance and creepage distances both between the power connection bolts 30 and between the power connection bolts 30 and the electrically conductive stator or housing components. In this exemplary embodiment, the power connection bolts 30 have flattened areas with a threaded hole to which an electrical conductor can be screwed.

FIG. 4 also shows that the first busbars 8 and the second busbars 18 are connected to the common high-voltage terminal 7. The busbars 8,18 are accommodated at least in sections in an annular or ring-segment-shaped insulating body 19, wherein the insulating body 19 has an E-shaped contour in cross-section with two radially spaced-apart grooves 20, 21 open on one side, in which the busbars 8,18 are accommodated.

The connecting lugs 29, which connect the busbar 8,18 with the connecting bolts 30, are intentionally thin and angled several times in this exemplary embodiment. As a result, relative position deviations and/or small relative movements and/or axial movements, which can arise, for example, due to component tolerances, elastic component deformations or thermal expansions between the busbars 8,18 and the power connection bolts 30, can be compensated for by a deformation (preferably an elastic deformation) of the connecting lugs 29. This compensation capacity of the connecting lugs 29 is particularly useful in the motor concept shown, since the stator 4 of this axial flux machine 1 is screwed radially to a side wall of the housing 23 on one axial side of the motor near the shaft bearings and the base 31 of the power connection bolt 30 is connected to the housing 23 radially outside the rotor 17 and radially outside the busbars 8,18. Due to the spaced-apart fastening points of the stator 4, which also includes the busbar 8,18, and the power connection bolt 30, positional inaccuracies during assembly or position changes during operation of the axial flux machine 1 between the busbar 8, 18 and the power connection bolt 30 are very likely.

FIGS. 4-5 also show that all electrical conductors supplying power to the stator coils 5,25 have been arranged radially outside the stator coils 5,25. Due to the described construction principle and the wiring concept, no electrical conductors are required to supply the stator coils 5,25 in the radial area between the rotation axis of the axial flux machine 1 and the stator coils 5,25. In the radial area between the radial inner area and the radial outer area of the stator coils 5,25, no electrical connections are required between the stator coils 5,25. The stator coils 5,25 are wound in two layers, wherein a plurality of windings run axially in front of each other in a first winding layer.

At the end of this first layer of winding, the wire is pulled radially outwards slightly so that a second layer of winding can be wound around the outside of the first layer of winding. In this second winding layer, the wire is wound axially back to the beginning of the first winding layer. Therefore, both coil ends 9,10 of a stator coil 5,25 are located axially on one side of the corresponding stator coil. By arranging both coil ends 9,10 of the stator coils 5,25 on the same axial side radially outwards in the exemplary embodiment, the distance that the wires at the coil ends 9,10 have to travel to the busbars 8,18 is very short. This simplifies assembly, saves material (e.g. copper) and requires little installation space. All other described features, such as the fact that no electrical conductors are required radially inside or tangentially between the stator coils 5,25, also enable the axial flux machine 1 to be very compact in axial terms. No axial space needs to be provided for electrical conductors that supply the coils with power, and the mechanical and magnetic structure of the stator is not weakened radially inward by openings, recesses, free spaces or channels for electrical conductors that supply the coils.

FIG. 5 shows an arrangement of five coil pairs with their busbar 8,18 and phase connections 28. In FIG. 5, all electrical conductors already described in FIG. 4 and their connection points are clearly visible. In FIG. 5, the connection principle of the axial flux machine 1 shown is also clearly understandable. The electric axial flux machine 1 is supplied with power via the three phase connections 28. The current flow from a phase connection 28 is described below. Since this is a three-phase system, the current naturally does not only flow via one phase connection 28.

FIG. 5 also clearly shows that the stator coils 5,25 each have a first coil end 9 and a second coil end 10, wherein the first coil end 9 has a radially extending section 11 and an axially extending section 12, and the axially extending section 12 electrically contacts one of the busbars 8,18 and the second coil end 10 has a radially extending section 13 and an axially extending section 14, and the axially extending section 14 electrically contacts the star point rail.

The current flows from one of the three power connection bolts 30 into the busbars 8,18 connected thereto and is then divided into the pairs of stator coils 5,25 connected to this busbar 8,18. The current flows partially via one of the connecting lugs 24 of the busbar 8,18 into a connecting wire (coil input) of one of the coils 25 shown on the right-hand side. In the exemplary embodiment shown, the coil inputs are the wires arranged off-center relative to the coil body. The current then flows through the windings of the stator coil 25 to the coil output wire (centrally located wire). The coil output wire of the first stator coil 25 of the coil pair (coil on the right side) is connected to the coil input wire (centrally arranged wire) of the left stator coil 5. The current thus flows into the second stator coil 5 of the series-connected coil pair and then flows through its windings to the coil output wire (off-center wire), which is connected to the star point rail. From the star point rail, the current flows back to the other two phase connections 28 of the axial flux machine 1. The current flows back from the star point rail through stator coils 5,25, which are connected to the other phase connections 28. Since the connection principle of all stator coils 5,25 is comparable, the current flows through these stator coils 5,25 as just described only in the opposite direction and thus passes the mentioned elements in reverse order.

Because the stator coils 5,25 of a coil pair are connected with their wires leading out of the center of the coil body, and the busbars 8,18 are designed in such a way that the wires branching off-center from the coil bodies always meet the correct connecting lug of the respective correct current-carrying busbar 8,18, all stator coils 5,25 can be identical in their construction. This concerns both the external shape of the stator coils 5,25, and also the winding direction of the stator coils 5,25.

FIGS. 4-5 describe how a power supply system consisting of a star point rail and three busbars (current phase U, current phase V and current phase W) can supply power to all stator coils 5,25 connected in series to form a pair of coils. Alternatively, it is also possible to dispense with the series connection of the opposing stator coils 5,25. This is also possible with a power supply system consisting of a star point rail and three current busbars (current phase U, current phase V and current phase W). Each stator coil 5,25 is then directly connected to one of the busbars 8,18 and the other end of the stator coil 5,25 is then connected to the star point ring. Alternatively, two star point rings can be used, so that one star point ring connects all stator coils 5,25 of one stator half or one stator body 15,16 and the other star point ring then connects all stator coils 5,25 of the other stator half or the other stator body 15,16.

Another alternative power supply system can be formed from two star point rails and six busbars. Then, each stator half or each stator body 15,16 has its own power supply system consisting of a star point rail and three busbars. The two power systems can use the same three phase connections or each power system can be equipped with three phase connections. Each stator coil is then always connected on one side to a busbar of its stator half or stator body 15,16 and with the other end to the star point rail of its stator half or stator body 15,16.

In all described connection variants, the star point rail can always be replaced by several connecting elements, each of which electrically connects the coil outputs of a coil connected to phase U, one to phase V and one to phase W. Even with these alternative connection variants, the power supply systems can be arranged radially outside the rotor 17. For example, by using insulating bodies with an increased number of slots, more current-carrying rails can be arranged in the annular space radially outside the rotor 17. In principle, the delta connection can also be used alternatively. In this case, the star point rail is no longer required. The coils are then connected at both ends to a different busbar (two different current phases). Alternatively, a separate annular space can be arranged radially outside the rotor 17 or radially outside the stator coils 5,25 of the respective stator half or the respective stator body 15,16 for each stator half or each stator body 15,16.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

The terms “radial”, “axial”, “tangential”, and “circumferential direction” used in this disclosure disclosure always refer to the axis of rotation R of the axial flux machine 1.

### LIST OF REFERENCE SYMBOLS

1 Axial flux machine
2 Drive train
3 Motor vehicle
4 Stator
5 Stator coils
6 Power electronics
7 High-voltage terminal
8 Busbars
9 Coil end
10 Coil ends
11 Section
12 Section
13 Section
14 Section
15 Stator body
16 Stator body
17 Rotor
18 Busbars
19 Insulating body
20 Groove
21 Groove
22 Rotor shaft
23 Housing
24 Connecting lugs
25 Stator coils
26 Insulating insert
27 Stator casing
28 Phase connections
29 Connecting lug
30 Power connection bolt
31 Base

1. An electric axial flux machine comprising:
a stator having a plurality of stator coils distributed over the a circumference of the stator and
power electronics for supplying current to the stator coils and
a high-voltage terminal for establishing an electrical connection between the stator coils and the power electronics,
wherein busbars are located above the stator coils in a radial direction, said busbars enclosing, in an annular manner, the stator and/or a rotor that can be rotated relative to the stator and electrically conductively connecting the stator coils to the high-voltage terminal.

2. The axial flux machine according to claim 1, wherein:
the high-voltage terminal is positioned radially above the busbars

3. The axial flux machine according to claim 1, wherein:
the rotor of the axial flux machine has a first disc-shaped stator body and a second disc-shaped stator body axially spaced therefrom and a rotor is arranged axially between the first stator body and the second stator body,
wherein the first stator body has a plurality of first stator coils distributed over the circumference of the first stator body and the second stator body has a plurality of second stator coils distributed over the circumference of the second stator body,
first busbars are located above the first stator coils in the radial direction, said busbars enclosing, in an annular manner, the first stator body and electrically conductively connecting the first stator coils and/or the second stator coils to the high-voltage terminal and
second busbars are located above the second stator coils in the radial direction, said busbars enclosing, in an annular manner, the second stator body and/or the rotor and electrically conductively connecting the first stator coils and/or the second stator coils to the high-voltage terminal.

4. The axial flux machine according to claim 1, wherein:
the stator coils each have a first coil end and a second coil end, wherein
the first coil end has a radially extending section and an axially extending section, and the axially extending section electrically contacts one of the busbars or another coil and/or
the second coil end has a radially extending section and an axially extending section, and the axially extending section electrically contacts one of the busbars or another coil or a star point rail.

5. The axial flux machine according to claim 1, wherein:
the stator coils are substantially designed to be identical.

6. The axial flux machine according to claim 3, wherein:
the first busbar and the second busbar are substantially designed to be identical.

7. The axial flux machine according to claim 3, wherein:
the first busbars and the second busbars are connected to the common high-voltage terminal.

8. The axial flux machine according to claim 4, wherein:
the busbars and/or the star point rail are accommodated at least in sections in an annular or ring-segment-shaped insulating body.

9. The axial flux machine according to claim 8, wherein:
the insulating body has an E-shaped contour in cross-section with two radially spaced-apart grooves open on one side, in which the busbars are accommodated.

10. The axial flux machine according to claim 1, wherein:
a pair of coils arranged on opposite sides of the rotor are electrically connected in series.
